(19) United States
(12) Patent Application Publication
(10) Pub. No.: US 2016/0236855 A1
(43) Pub. Date: Aug. 18, 2016

(54) CONTAINER HAVING A FOLDED LABEL

(71) Applicant: PHILIP MORRIS PRODUCTS, S.A., Neuchatel (CH)

(72) Inventors: Lucas Chatelain, Lausanne (CH); Timothee Cailleaux, Divonne-les-Bains (FR); Ross Lange, Neuchatel (CH)

(21) Appl. No.: 15/025,590

(22) PCT Filed: Oct. 10, 2014
(86) PCT No.: PCT/EP2014/071801

§ 371 Date: Mar. 29, 2016

(30) Foreign Application Priority Data
Oct. 10, 2013 (EP) 13188164.1

(51) Int. Cl. B65D 85/10; A24F 15/00; B65D 5/02; B65C 3/08; B65D 75/14; B65D 5/00

(52) U.S. Cl. CPC B65D 85/1045; B65D 75/14; B65D 5/0085; B65D 5/0236; B65C 3/08; A24F 15/00; B65D 2203/02; B65D 2575/586

(57) ABSTRACT

The invention relates to a container (70) for consumer goods comprising a housing comprising a front housing wall (66), a back housing wall, two side housing walls (67), a bottom housing wall, and a housing opening. The container (70) further comprises an inner bundle (10) for receiving consumer goods and positioned within the housing, the inner bundle (10) comprising an inner bundle opening. The container (70) also comprises a label (30) comprising a cover panel (42) covering the inner bundle opening and a label flap (40), wherein the label flap (40) depends via a fold line (38) from the cover panel (42) and overlies at least part of the cover panel (42). The front housing wall (66) overlies the label fold line (38) and the inner bundle (10) underlies the label fold line (38). An edge of the label cover panel (42) extends beyond an edge of the inner bundle opening to define an edge portion of the label cover panel (42). The container (72) further comprises a non-permanent adhesive on the edge portion of the label cover panel (42) to releasably secure the edge portion to the inner bundle (10) such that the label (30) is retained in a closed position.

The present invention relates to a container for consumer goods, the container comprising a folded label covering an opening in an inner bundle. The present invention also relates to a method of making the container. The containers of the present invention find particular application as containers for smoking articles, such as for example cigarettes.

Consumer goods such as smoking articles are commonly packaged in rigid box shaped containers, such as hinged lid containers having a box portion and a lid connected to the box about a hinge line extending across the rear wall of the container, a so called FlipTop® box. In some cases, the container further includes an inner frame wrapped around at least a portion of the consumer goods. This may provide further rigidity to the container and protect the consumer goods. Where the inner frame extends above an upper edge of the box portion, the inner frame also provides a surface against which the lid can close.

The consumer goods may be comprised within an inner bundle that is housed within the box portion and the lid. Indeed, typically, for cigarette packs, the inner bundle is produced by folding an inner liner around a charge of cigarettes. The inner bundle may comprise an opening through which the consumer goods can be removed and a label covering the opening. To assist a consumer in opening the inner bundle, the label may comprises a non-tacky portion that does not adhere to the inner bundle and provides a portion for the consumer to grasp. However, since the label is typically formed from a flat sheet material, it may still be difficult for a consumer to separate the non-tacky portion of the label from the surface of the inner bundle.

Some prior art containers attempt to overcome this problem by folding the non-tacky portion of the label away from the inner bundle at any angle between 0 degrees and 180 degrees. However, whilst this may solve a problem for the consumer, it creates a problem during the manufacture of the container. In particular, once the folding force is removed the folded portion of the label may return to a position somewhere between the unfolded position and the folded position. Accordingly, the non-tacky portion will extend outwardly from the inner bundle and may become damaged further downstream in the manufacturing process or may catch on machine parts during transport between process steps, potentially leading to jams and machine down time.

Therefore, it would be desirable to provide a container for consumer goods, the container having an inner bundle that is both easy to manufacture and easy for the consumer to open.

The present invention provides a container for consumer goods, the container comprising a housing comprising a front housing wall, a back housing wall, two side housing walls, a bottom housing wall, and a housing opening. The container further comprises an inner bundle for receiving consumer goods and positioned within the housing, the inner bundle comprising an inner bundle opening. The container also comprises a label comprising a cover panel covering the inner bundle opening and a label flap, wherein the label flap depends via a fold line from the cover panel and overlies at least part of the cover panel. The front housing wall overlies the label fold line and the inner bundle underlies the label fold line. That is, the fold line is positioned between the front housing wall and the inner bundle. An edge of the label cover panel extends beyond an edge of the inner bundle opening to define an edge portion of the label cover panel. The container further comprises a non-permanent adhesive on the edge portion of the label cover panel to releasably secure the edge portion to the inner bundle such that the label is retained in a closed position.

The terms “front”, “back”, “top”, “bottom”, “side”, “left”, “right” and other terms used to describe relative positions of the components of containers according to the present invention refer to the container in an upright position with the opening through which the consumer goods are removed at the top end. In embodiments in which the container comprises a lid, the lid is moveable about a hinge line extending across the back of the container.

The term “longitudinal” refers to a direction from bottom to top or vice versa. The term “transverse” refers to a direction perpendicular to the longitudinal direction.

The term “panel” refers to a portion of the container formed from a single, continuous portion of material. The term “wall” refers more generally to a facet of the assembled container, for example the “front wall” of the housing defines a front facet of the container. A wall may be formed from a single panel, or a wall may be formed from two or more abutting or overlapping panels.

The term “non-permanent adhesive” is used herein to mean an adhesive that provides a bond between two materials so that the two materials can be easily separated after bonding with little or no damage to both materials. Non-permanent adhesives typically remain tacky such that they allow the two materials to be repeatedly bonded and separated without the need to apply more adhesive before each bond. In contrast, a “permanent adhesive” provides a permanent bond between two materials. That is, the two materials cannot be separated after bonding without applying excessive force which may damage one or both of the materials.

A container in accordance with the present invention comprises a label on the inner bundle, the label comprising a portion that is folded to form a label flap that overlies at least a portion of a cover panel formed by the label. Advantageously, the label flap provides a portion of the label that is easier for a consumer to grasp and therefore facilitates opening of the inner bundle. Furthermore, by positioning the label fold line between the front housing wall and the inner bundle, the label flap is retained in the folded position so that the label flap rests substantially parallel to the cover panel. That is, the label flap is folded through an angle of about 180 degrees with respect to the cover panel. This prevents the label flap from extending outwardly from the inner bundle and therefore minimizes the risk of the label flap becoming damaged during the subsequent manufacturing process.

Containers in accordance with the present invention also comprise a non-permanent adhesive on an edge portion of the label cover panel, which advantageously maintains the label in the closed position while also allowing repeated opening and closing of the label.

The housing opening and the inner bundle opening are both sized such that one or more consumer goods may be removed from the inner bundle through the openings. The housing opening overlies at least part of the inner bundle opening, preferably the entire inner bundle opening. Although the inner bundle opening may be larger than the housing opening or the same size as the housing opening, the inner bundle opening is preferably smaller than the housing opening. Utilising an inner bundle opening that is smaller than the housing opening can allow the label to be smaller than the housing opening in at least one dimension. This advantageously facilitates lifting of the cover panel to open the inner bundle without the need to remove the inner bundle from the housing.

Preferably, a portion of the label flap extends beyond an upper edge of the front housing wall so that a distal edge of the label flap distal from the fold line underlies the housing opening. This facilitates grasping of the label flap by a consumer without the need to remove or partially remove the inner lining from the housing, while still retaining the fold line between the housing and the inner bundle. The vertical length of the label flap portion between the front housing wall upper edge and the label flap distal edge is preferably between about 2 millimetres and about 30 millimetres, more preferably between about 5 millimetres and about 15 millimetres. The vertical length refers to the longest extent of the label flap in the vertical direction.

The inner bundle may comprise a sheet material, a so called “inner liner” that is folded around the consumer goods during manufacture of the container. Preferably, the inner liner of the inner bundle is sealable around the consumer goods in order to provide a barrier, for example against the ingress or loss of moisture or flavour. The inner liner preferably comprises a line of weakness that defines an inner bundle cover panel in the inner liner. Upon first opening the inner bundle, the inner liner is broken along the line of weakness so that the inner bundle cover panel can be lifted and consumer goods removed from within the inner bundle. In this case, the line of weakness defines the perimeter of the inner bundle opening and the inner bundle cover panel covers the inner lining opening when closed. Preferably, the line of weakness is one of a scoring line, creasing line or perforation line or combinations thereof. In some embodiments, the line of weakness may be formed from a scoring line or creasing line on either side of the inner liner. Further, these scoring lines or creasing lines on either side of the inner liner may coincide spatially or may be offset from each other by a certain distance, for example between about 0.1 mm and about 3 mm. The inner bundle opening may be arranged within the inner liner, that is, the inner bundle opening may be bordered on all four sides by the inner liner before the inner liner is folded around the consumer goods. Alternatively, the opening may be located at one edge of the inner liner, that is, the inner bundle opening may be bordered on three sides by the inner liner before the inner liner is folded around the consumer goods and the forth edge of the inner bundle opening is comprised of an edge of the inner liner. In still further embodiments, a first part of the inner bundle opening may be located on a first edge of the inner liner and a second part of the inner bundle opening may be located on a second edge of the inner liner such that the opening is then formed in the inner bundle when the inner liner is folded around the consumer goods and the two parts in the inner liner form together the inner bundle opening. Preferably, these two parts of the inner liner are attached to each other, for example glued or sealed.

In embodiments in which the inner bundle comprises an inner bundle cover panel, an area of the label cover panel is preferably affixed to a portion of the inner bundle cover panel using a permanent adhesive. By affixing a portion of the label cover panel to the inner bundle cover panel with a permanent adhesive, the consumer can lift both the label cover panel and the inner bundle cover panel by grasping and lifting only the label flap.

To prevent the label flap from sticking to other parts of the container, the label flap is preferably non-tacky. That is, the label flap is preferably free from a tacky adhesive such as a non-permanent adhesive.

In some embodiments, the housing may further comprise a first sheet material folded around the inner bundle to form at least a first front panel, and a second sheet material folded around the first sheet material and the inner bundle to form a second front panel, two second side panels, a bottom panel and a back panel. The first front panel and the second front panel each form part of the front housing wall, and at least one of the first and second front panels overlies the label fold line. Preferably, the first sheet material also forms two side panels around the inner bundle.

For example, in some embodiments the container may be a hinge lid container, wherein the first sheet material is folded to form an inner frame and the second sheet material is folded to form a box portion and a lid portion. The inner frame and the box portion each comprise a front panel that co-operate to form the front wall of the housing, wherein the box portion front panel overlies at least a portion of the inner frame front panel. The lid portion also comprises one or more lid front panels that form a lid front wall. The label fold line underlies the inner frame front panel, the box portion front panel, or both.

The upper edge of the housing front wall can be formed by an upper edge of the box portion front panel, an upper edge of the inner frame front panel, or both. Preferably, the inner frame front panel extends above the box portion front panel so that the upper edge of the housing front wall is defined by the upper edge of the inner frame front panel. With this arrangement, the inner frame front panel advantageously provides a surface against which the lid portion front wall can close, so that when the lid portion is in the closed position the lid portion front wall and the box portion front wall lie in substantially the same plane and define an outer surface of a front wall of the container.

The housing opening can be defined by the first folded sheet material, the second folded sheet material, or both. In embodiments in which the container is a hinge lid box and the first folded sheet material forms an inner frame that extends above an upper edge of a box portion formed by the folded second sheet material, an edge of the housing opening is preferably defined by a portion of the inner frame.

Consumer goods may be contained within the container during manufacture, so that containers in accordance with the present invention may comprise one or more consumer goods contained within the inner bundle. The one or more consumer goods may be a plurality of smoking articles, such as a plurality of cigarettes.

The container may take any suitable form for housing consumer goods. For example, the container may be a hinge-lid container having one or more hinge lids connected to a box housing the consumer goods, as described above. Alternatively, the container may be a slide and shell container having an inner slide for housing the consumer goods mounted within an outer shell. Where the container is a slide and shell container, the outer shell or the inner slide may comprise one or more hinge lids.

The housing and the inner bundle may be formed from any suitable materials including, but not limited to, cardboard, paperboard, plastic, metal, or combinations thereof. Preferably, the housing is formed from one or more folded laminar cardboard blanks. Preferably, the cardboard has a weight of between about 100 grams per square metre and about 350 grams per square metre.

Preferably, the inner bundle is formed of metal foil, metallised paper or a metallised polymeric film.

Containers according to the invention may be in the shape of a rectangular parallelepiped, with right-angled longitudinal and right-angled transverse edges. Alternatively, the container may comprise one or more rounded longitudinal edges, rounded transverse edges, bevelled longitudinal edges or bevelled transverse edges, or combinations thereof. For example, the housing may comprise, without limitation:

one or two longitudinal rounded or bevelled edges on the front wall, and/or one or two longitudinal rounded or bevelled edges on the back wall.

one or two transverse rounded or bevelled edges on the front wall, and/or one or two transverse rounded or bevelled edges on the back wall.

one longitudinal rounded edge and one longitudinal bevelled edge on the front wall, and/or one transverse rounded edge and one transverse bevelled edge on the back wall.

one or two transverse rounded or bevelled edges on the front wall and one or two longitudinal rounded or bevelled edges on the front wall.

two longitudinal rounded or bevelled edges on a first side wall or two transverse rounded or bevelled edges on a second side wall.

Where the housing comprises one or more rounded edges and is made from one or more laminar blanks, preferably the blanks comprise three, four, five, six or seven scoring lines or creasing lines to form each rounded edge in the assembled housing. The scoring lines or creasing lines may be either on the inside of the housing or on the outside of the housing. Preferably, the scoring lines or creasing lines are spaced from each other by between about 0.3 mm and about 4 mm.

Preferably, the spacing of the creasing lines or scoring lines is a function of the thickness of the laminar blank. Preferably, the spacing between the creasing lines or scoring lines is between about 0.5 and about 4 times larger than the thickness of the laminar blank.

Where the housing comprises one or more bevelled edges, preferably each bevelled edge has a width of between about 1 mm and about 10 mm, preferably between about 2 mm and about 6 mm. Alternatively, the housing may comprise a double bevel formed by three parallel creasing or scoring lines that are spaced such that two distinct bevels are formed on the edge of the housing.

Where the housing comprises a bevelled edge and is made from one or more laminar blanks, the bevel may be formed by two parallel creasing lines or scoring lines in the laminar blank. The creasing lines or scoring lines may be arranged symmetrically to the edge between a first wall and a second wall. Alternatively, the creasing lines or scoring lines may be arranged asymmetrically to the edge between the first wall and the second wall, such that the bevel reaches further into the first wall of the housing than into the second wall of the housing. Alternatively, the container may have a non-rectangular transversal cross section, for example polygonal such as triangular or hexagonal, or oval, semi-oval, circular or semi-circular.

Containers according to the invention find particular application as packs for elongate smoking articles such as, for example, cigarettes, cigars or cigarillos. It will be appreciated that through appropriate choices of the dimensions thereof, containers according to the invention may be designed for different numbers of conventional size, king size, super-king size, slim or super-slim cigarettes.

Through an appropriate choice of the dimensions thereof, containers according to the invention may be designed to hold different total numbers of smoking articles, or different arrangements of smoking articles. For example, through an appropriate choice of the dimensions thereof, containers according to the invention may be designed to hold a total of between ten and thirty smoking articles.

The smoking articles in the container may be arranged in different collations, depending on the total number of smoking articles. For example, the smoking articles may be arranged in a single row of six, seven, eight, nine or ten. Alternatively, the smoking articles may be arranged in two or more rows. The two or more rows may contain the same number of smoking articles. For example, the smoking articles may be arranged in: two rows of five, six, seven, eight, nine or ten; three rows of five or seven; or four rows of four, five or six. Alternatively, the two or more rows may include at least two rows containing different number of smoking articles to each other. For example, the smoking articles may be arranged in: a row of five and a row of six (5-6); a row of six and a row of seven (6-7); a row of seven and a row of eight (7-8); a middle row of five and two outer rows of six (6-5-6); a middle row of five and two outer rows of seven (7-5-7); a middle row of six and two outer rows of five (5-6-5); a middle row of six and two outer rows of seven (7-6-7); a middle row of seven and two outer rows of six (6-7-6); a middle row of nine and two outer rows of eight (8-9-8); or a middle row of six with one outer row of five and one outer row of seven (5-6-7).

Containers according to the present invention may hold smoking articles of the same type or brand, or of different types or brands. In addition, both filterless smoking articles and smoking articles with various filter tips may be contained, as well as smoking articles of differing length (for example, between about 40 mm and about 180 mm), diameter (for example, between about 4 mm and about 9 mm). In addition, the smoking articles may differ in strength of taste, resistance to draw and total particulate matter delivery. Preferably, the dimensions of the container are adapted to the length of the smoking articles, and the collation of the smoking articles. Typically, the outer dimensions of the container are between about 0.5 mm to about 5 mm larger than the dimensions of the bundle or bundles of smoking articles housed inside the container.

The length, width and depth of containers according to the invention may be such that, in the closed position, the resultant overall dimensions of the container are similar to the dimensions of a typical disposable hinge-lid pack of twenty cigarettes.

Preferably, containers according to the invention have a height of between about 60 mm and about 150 mm, more preferably a height of between about 70 mm and about 125 mm, wherein the height is measured from a top wall to the bottom housing wall at the exterior of the container.

Preferably, containers according to the invention have a width of between about 12 mm and about 150 mm, more preferably a width of between about 70 mm and about 125 mm, wherein the width is measured from one side housing wall to the other side housing wall at the exterior of the container.

Preferably, containers according to the invention have a depth of between about 6 mm and about 100 mm, more preferably a depth of between about 12 mm and about 25 mm wherein the depth is measured from the front housing wall to the back housing wall at the exterior of the container.

Preferably, the ratio of the height of the container to the depth of the container is in between about 0.3 to 1 and about 10 to 1, more preferably between about 2 to 1 and about 8 to 1, most preferably between about 3 to 1 and 5 to 1.

Preferably, the ratio of the width of the container to the depth of the container is in between about 0.3 to 1 and about 10 to 1, more preferably between about 2 to 1 and about 8 to 1, most preferably between about 2 to 1 and 3 to 1.

As well as housing a bundle of smoking articles, the container may further comprise other consumer goods, for example matches, lighters, extinguishing means, breath-fresheners or electronics. The other consumer goods may be attached to the outside of the container, contained within the container along with the smoking articles, in a separate compartment of the container or combinations thereof.

The exterior surfaces of containers according to the invention may be printed, embossed, debossed or otherwise embellished with manufacturer or brand logos, trademarks, slogans and other consumer information and indicia.

The present invention also extends to a method of manufacturing the container in accordance with any of the embodiments described above. Accordingly, the present invention provides a method of manufacturing a container for consumer goods, the method comprising a first step of providing an inner bundle for receiving consumer goods, the inner bundle comprising an inner bundle opening. A label formed from a sheet material is also provided and the label is affixed to the inner bundle. The label is then folded so that the label comprises a cover panel covering the inner bundle opening and a label flap, wherein the label flap depends via a fold line from the cover panel and wherein the label flap overlies at least part of the cover panel. An edge of the label cover panel extends beyond an edge of the inner bundle opening to define an edge portion of the label cover panel, and a non-permanent adhesive on the edge portion of the label cover panel releasably secures the edge portion to the inner bundle such that the label is retained in a closed position. A sheet material is then folded around the inner bundle to form a housing in which the inner bundle is positioned, the housing comprising a front housing wall, a back housing wall, two side housing walls, a bottom housing wall and a housing opening, wherein the front housing wall overlies the label fold line and wherein the inner bundle underlies the label fold line.

In some embodiments, the step of folding the sheet material around the inner bundle defines a portion of the label flap that extends beyond an upper edge of the front housing wall so that a distal edge of the label flap distal from the fold line underlies the housing opening. Preferably, the length of the label flap portion between the front housing wall upper edge and the label flap distal edge is between about 2 millimetres and about 30 millimetres, more preferably between about 5 millimetres and about 15 millimetres.

The step of folding a sheet material around the inner bundle to form a housing may comprise a first step of folding a first sheet material around the inner bundle to form at least a first front panel and two first side panels. In a second step, a second sheet material is folded around the first sheet material and the inner bundle to form a second front panel, two second side panels, a bottom panel and a back panel. The first front panel and the second front panel each form part of the front housing wall, and at least one of the first and second front panels overlies the label fold line.

In those embodiments in which the container is a hinge lid container, the folded first sheet material may form an inner frame and the folded second sheet material may form a box portion and a lid portion, as described above.

To prevent the label flap from sticking to other parts of the container, the label flap is preferably non-tacky. That it, the label flap is preferably free from a tacky adhesive such as a non-permanent adhesive.

Preferably, the step of providing an inner bundle comprises folding a sheet material around one or more consumer goods to form an inner bundle such that the one or more consumer goods are contained within the inner bundle. The one or more consumer goods may be a plurality of smoking articles, such as a plurality of cigarettes.

The invention will now be further described by way of example only with reference to the drawings in which:

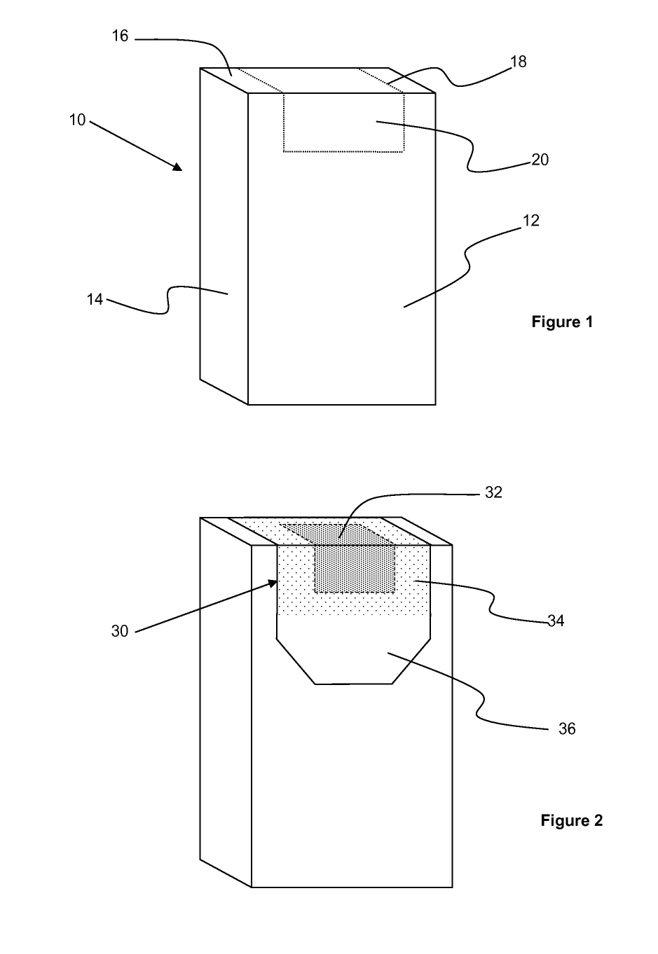

FIGS. 1 to 4 show intermediate steps of an exemplary process for forming a container in accordance with the present invention; and

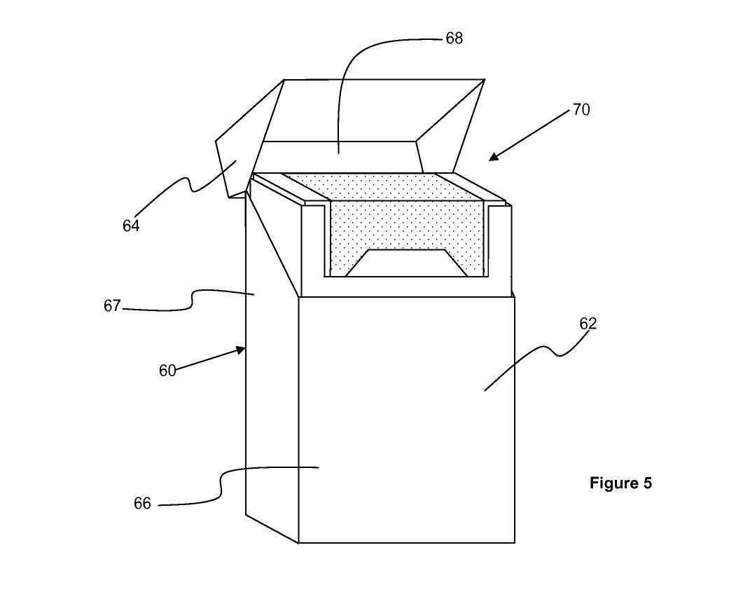

FIG. 5 shows a container according to the present invention.

FIG. 1 shows an inner bundle 10 formed by folding a sheet of metallised polyethylene film around a bundle of cigarettes, in a first step of a method according to the present invention. The inner bundle 10 comprises a front wall 12, two side walls 14, a back wall, a top wall 16 and a bottom wall. A perforation line 18 is formed in the metallised paper prior to folding the paper to form the inner bundle 10. The perforation line 18 defines an inner bundle cover panel 20 that covers an inner bundle opening in the front wall 12 and the top wall 16 of the inner bundle 10.

In a second step shown in FIG. 2, a label 30 is affixed to the inner bundle 10 over the inner bundle cover panel 20. The label 30 comprises an area of permanent adhesive 32 on the underside of the label 30. The permanent adhesive 32 permanently bonds the label 30 to the inner bundle cover panel 20. The permanent adhesive 32 overlies only a portion of the inner bundle cover panel 20 so that the label 30 is not permanently bonded to any other part of the inner bundle 10. For clarity, the area of permanent adhesive 32 is not shown in subsequent Figures.

The label 30 further comprises an area of non-permanent adhesive 34 that surrounds the area of permanent adhesive 32. The non-permanent adhesive 34 is provided on an underside of the label 30 and overlies an area of the inner bundle 10 surrounding the inner bundle cover panel 20. Therefore, when a consumer subsequently opens the inner bundle 10 by lifting the label 30 and breaking the perforation line 18 to lift the inner bundle cover panel 20, the non-permanent adhesive 34 allows the label 30 to re-adhere to the area of the inner bundle 10 surrounding the inner bundle opening so that the inner bundle 10 can be repeatedly opened and closed.

The label 30 also comprises a non-tacky area 36 that is free from adhesive.

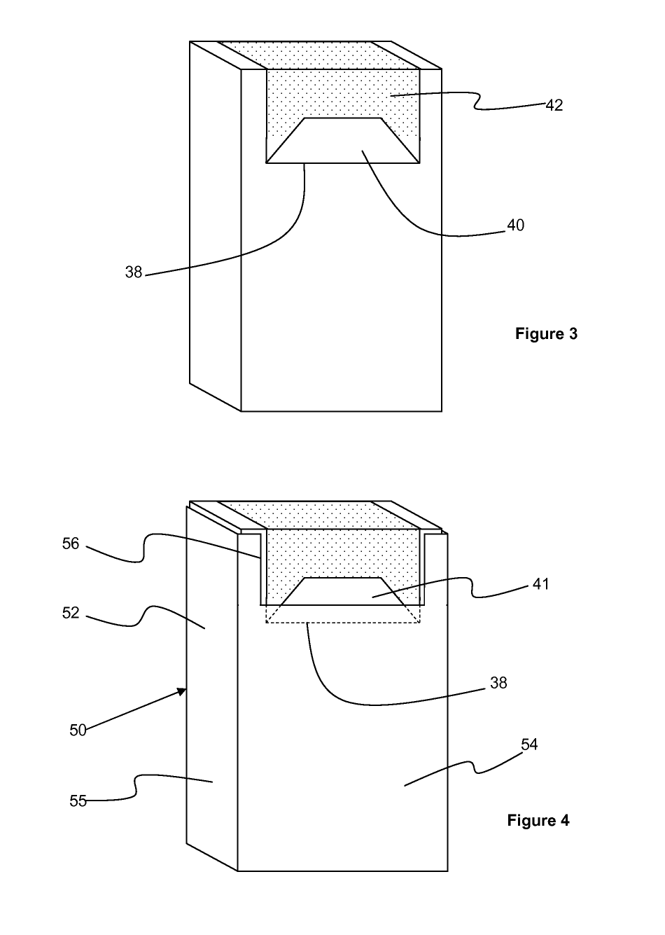

In a third step, as shown in FIG. 3, a portion of the non-tacky area 36 is folded outwardly about a fold line 38 through an angle of about 180 degrees to define a label flap 40 that overlies part of the remainder of the label 30. The remainder of the label 30 forms a label cover panel 42 that overlies the inner bundle cover panel 20.

Next, a first laminar cardboard blank 50 is folded around the front wall 12 and the side walls 14 of the inner bundle 10 to form an inner frame 52, as shown in FIG. 4. The inner frame 52 comprises a front panel 54 having a cut-out 56 that overlies the inner bundle cover panel 20. The inner frame front panel 54 overlies the label fold line 38 so that the label flap 40 is retained in a substantially flat position against the label cover panel 42, which reduces the risk of damage to the label flap 40 during subsequent manufacturing steps. The inner frame cut-out 56 overlies part of the label flap 40, which forms a distal portion 41 of the label flap 40 that a consumer can easily grasp to open the inner bundle 10.

Finally, as shown in FIG. 5, a second laminar cardboard blank 60 is folded around the inner frame 52 and the inner bundle 10 to form a box portion 62 and a lid portion 64. The inner frame 52, the box portion 62 and the lid portion 64 together define a housing comprising a front housing wall 66, a back housing wall, two side housing walls 67, a bottom housing wall and a top housing wall 68. The housing opening is delimited by the housing back wall and the upper edges of the inner frame front panel 54 and the inner frame side panels 55.

The inner bundle 10 and the housing together form a container 70 in accordance with the present invention.

1. A container for consumer goods, the container comprising:
a housing comprising a front housing wall, a back housing wall, two side housing walls, a bottom housing wall, and a housing opening;
an inner bundle for consumer goods, wherein the inner bundle is positioned within the housing, the inner bundle comprising an inner bundle opening; and
a label comprising a cover panel covering the inner bundle opening and a label flap, wherein the label flap depends via a fold line from the cover panel and overlies at least part of the cover panel;
wherein the front housing wall overlies the label fold line, wherein the inner bundle underlies the label fold line, and wherein an edge of the label cover panel extends beyond an edge of the inner bundle opening to define an edge portion of the label cover panel, the container further comprising a non-permanent adhesive on the edge portion of the label cover panel to releasably secure the edge portion to the inner bundle such that the label is retained in a closed position.

2. A container according to claim 1, wherein a portion of the label flap extends beyond an upper edge of the front housing wall so that a distal edge of the label flap distal from the fold line underlies the housing opening.

3. A container according to claim 1, wherein the vertical length of the label flap portion between the front housing wall upper edge and the label flap distal edge is between 2 millimetres and 30 millimetres.

4. A container according to claim 1, wherein the housing comprises:
a first sheet material folded around the inner bundle to form at least a first front panel; and
a second sheet material folded around the first sheet material and the inner bundle to form a second front panel, two second side panels, a bottom panel and a back panel;
wherein the first front panel and the second front panel each form part of the front housing wall, and wherein at least one of the first and second front panels overlies the label fold line.

5. A container according to claim 1, wherein the label flap is non-tacky.

6. A container according to claim 1, further comprising one or more consumer goods contained within the inner bundle.

7. A container according to claim 6, wherein the one or more consumer goods is a plurality of smoking articles.

8. A method of manufacturing a container for consumer goods, the method comprising the steps of:
providing an inner bundle for receiving consumer goods, the inner bundle comprising an inner bundle opening;
providing a label formed from a sheet material and affixing the label to the inner bundle;
folding the label so that the label comprises a cover panel covering the inner bundle opening and a label flap, wherein the label flap depends via a fold line from the cover panel, wherein the label flap overlies at least part of the cover panel, and wherein an edge of the label cover panel extends beyond an edge of the inner bundle opening to define an edge portion of the label cover panel, wherein a non-permanent adhesive is provided on the edge portion of the label cover panel to releasably secure the edge portion to the inner bundle such that the label is retained in a closed position; and
folding a sheet material around the inner bundle to form a housing in which the inner bundle is positioned, the housing comprising a front housing wall, a back housing wall, two side housing walls, a bottom housing wall and a housing opening, wherein the front housing wall overlies the label fold line and wherein the inner bundle underlies the label fold line.

9. A method according to claim 8, wherein the step of folding the sheet material around the inner bundle defines a portion of the label flap that extends beyond an upper edge of the front housing wall so that a distal edge of the label flap distal from the fold line underlies the housing opening.

10. A method according to claim 9, wherein the vertical length of the label flap portion between the front housing wall upper edge and the label flap distal edge is between 2 millimetres and 30 millimetres.

11. A method according to claim 8, wherein the step of folding a sheet material around the inner bundle to form a housing comprises:
folding a first sheet material around the inner bundle to form at least a first front panel; and
folding a second sheet material around the first sheet material and the inner bundle to form a second front panel, two second side panels, a bottom panel and a back panel;
wherein the first front panel and the second front panel each form part of the front housing wall, and wherein at least one of the first and second front panels overlies the label fold line.

12. A method according to claim 8, wherein the label flap is non-tacky.

13. A method according to claim 8, wherein the step of providing an inner bundle comprises folding a sheet material around one or more consumer goods to form an inner bundle such that the one or more consumer goods are contained within the inner bundle.

14. A method according to claim 13, wherein the one or more consumer goods is a plurality of smoking articles.

15. A container according to claim 2, wherein the vertical length of the label flap portion between the front housing wall upper edge and the label flap distal edge is between 2 millimetres and 30 millimetres.

16. A container according to claim 2, wherein the housing comprises:
a first sheet material folded around the inner bundle to form at least a first front panel; and
a second sheet material folded around the first sheet material and the inner bundle to form a second front panel, two second side panels, a bottom panel and a back panel;
wherein the first front panel and the second front panel each form part of the front housing wall, and wherein at least one of the first and second front panels overlies the label fold line.

17. A container according to claim 3, wherein the housing comprises:
a first sheet material folded around the inner bundle to form at least a first front panel; and
a second sheet material folded around the first sheet material and the inner bundle to form a second front panel, two second side panels, a bottom panel and a back panel;
wherein the first front panel and the second front panel each form part of the front housing wall, and wherein at least one of the first and second front panels overlies the label fold line.

18. A method according to claim 9, wherein the step of folding a sheet material around the inner bundle to form a housing comprises:
folding a first sheet material around the inner bundle to form at least a first front panel; and
folding a second sheet material around the first sheet material and the inner bundle to form a second front panel, two second side panels, a bottom panel and a back panel;
wherein the first front panel and the second front panel each form part of the front housing wall, and wherein at least one of the first and second front panels overlies the label fold line.

19. A method according to claim 10, wherein the step of folding a sheet material around the inner bundle to form a housing comprises:
folding a first sheet material around the inner bundle to form at least a first front panel; and
folding a second sheet material around the first sheet material and the inner bundle to form a second front panel, two second side panels, a bottom panel and a back panel;
wherein the first front panel and the second front panel each form part of the front housing wall, and wherein at least one of the first and second front panels overlies the label fold line.
